(19) United States
(12) Patent Application Publication
(10) Pub. No.: US 2022/0198308 A1
(43) Pub. Date: Jun. 23, 2022

(54) CLOSED LOOP ADAPTIVE PARTICLE FORECASTING

(71) Applicant: OHIO STATE INNOVATION FOUNDATION, Columbus, OH (US)

(72) Inventors: Mrinal KUMAR, Columbus, OH (US); Chao YANG, Columbus, OH (US)

(21) Appl. No.: 17/605,840

(22) PCT Filed: May 21, 2020
(86) PCT No.: PCT/US20/34048

§ 371 Date: Oct. 22, 2021

Related U.S. Application Data
(60) Provisional application No. 62/851,453, filed on May 22, 2019.

(51) Int. Cl. G06N 7/00; G06N 20/20

(52) U.S. Cl. CPC G06N 7/005; G06N 20/20

(57) ABSTRACT

Forecasting is built around an adaptive particle approach, which may be classified under the broad umbrella of Monte Carlo methods. Performance can be self-monitoring, and an ensemble can be adaptively modified to maintain performance within prescribed bounds. If underperforming, additional particles can be added until performance is again within the prescribed bounds. If overperforming, particles can optionally be removed until performance is within the prescribed bounds.

### CROSS-REFERENCE TO RELATED APPLICATIONS

This application claims the benefit of U.S. Provisional Application No. 62/851,453, filed May 22, 2019, and entitled “CLOSED LOOP ADAPTIVE PARTICLE FORECASTING.” The entirety of this application is incorporated herein by reference.

### STATEMENT REGARDING FEDERALLY SPONSORED RESEARCH

Support was provided by the National Science Foundation (NFS), grant number ECCS-1254244, and the Air Force Office of Scientific Research (AFOSR), grant number FA9550-17-1-0307.

### BACKGROUND

Monte Carlo methods are a class of computational algorithms that rely on random sampling to find an approximate solution to a numerical problem that is otherwise intractable. Randomly generated numbers can be used as input into systems to generate a range of solutions. The likelihood of a particular solution can be determined by dividing by a total number of trials. For example, the probability of winning a particular game of solitaire corresponds to the number of games won divided by the total number of games played, in which the games are simulations guided by random numbers. By using a larger number of trials, or playing more games, the solution can be more accurately determined, in accordance with the law of large numbers.

A sequential Monte Carlo method, or particle filter method, can be employed to enable estimation of hidden state within a state space of a subject of interest by combining the power of Monte Carlo methods with Bayesian inference methods. Bayesian methods provide support for dynamic state estimation problems by constructing a probability density function (PDF) of state based on all available information. This approach has been adapted to estimate the PDF based on random samples, or particles. As the number of particles becomes very large, an equivalent and optimal representation or simulation of the PDF is provided. Particle filter methods are popular due to their simplicity and scalability to complex problems.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to closed loop adaptive particle forecasting. A forecast is achieved with guaranteed performance in terms of estimation accuracy of defined system quantities of interest. The forecasting mechanism is built around an adaptive particle approach. Rather than employing fixed sized particle ensembles over an entire duration of forecasting, the subject approach is designed to self-monitor its performance and modify its ensemble to maintain the estimate of quantities of interest within prescribed bounds. If measured accuracy is less than a prescribed accuracy, the current ensemble is underperforming and can be enhanced by adding particles that bring the accuracy within bounds. In one instance, a batch of particles can be added in which the size of the batch and particles populating the batch are optimally determined. If measured accuracy is greater than prescribed accuracy, the current ensemble is overperforming and can be optionally downsized by removing particles in the interest of reducing computational burden.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 is a schematic block diagram of an adaptive particle forecasting system.

FIG. 2 is a schematic block diagram of a sample adaptation component.

FIG. 3 illustrates a simulated annealing approach associated with particle enhancement

FIG. 4 is a schematic block diagram of an adaptive particle forecasting system capable of learning a model.

FIG. 5 is a flow chart diagram of a method of ensemble adaptation.

FIG. 6 is a flow chart diagram of a particle addition method.

FIG. 7 is a flow chart diagram of a method of batch particle addition.

FIG. 8 is a flow chart diagram of a method of particle removal.

FIG. 9 is a flow chart diagram of a method of determining batch size.

FIG. 10 is a flow chart diagram of a method of generating a model.

FIG. 11 is a schematic block diagram illustrating a suitable operating environment for aspects of the subject disclosure.

### DETAILED DESCRIPTION

Despite their popularity due to simplicity and scalability, conventional particle filter methods for forecasting are unable to provide performance guarantees in quantifying system uncertainty because such methods employ fixed size particle ensembles. This is problematic because it is impossible to know the quality of a forecast. One solution is to start with a large ensemble and hope that it works over the entire duration of forecasting. However, there are at least two problems with this approach.

First, choosing a large ensemble is essentially a gamble. Currently, there is no means for knowing how accurate a derived system forecast is with respect to demands posed by decision making needs. For example, assume a company operates a satellite, which is under threat of collision with a debris object. The company must decide whether to burn fuel to move the satellite to a new orbit in order to reduce or eliminate danger from the debris object. To make this decision, the company needs accurate estimates of the probability of a collision between the satellite and the debris object over the next few weeks, or even months. Since burning fuel reduces mission lifetime, the company requires highly accurate estimates of collision probability to be confident that the fuel expenditure is warranted. Conventional particle filter methods cannot guarantee whether the desired level of accuracy needed for making such decisions has been achieved.

Second, since guaranteed accuracy is not possible with conventional techniques, users often over compute. In other words, the practice is to be overly conservative and, based on past experience, employ ensembles that are expected to be large enough. For moderate to highly complex systems (e.g., combustion process inside a jet engine), this might be too computationally burdensome. Moreover, such over-computation still does not provide any guarantees of accuracy.

The subject disclosure pertains to a platform that provides system forecasts with guaranteed performance, while also providing the flexibility of using the smallest possible ensemble to achieve prescribed accuracy. This is achieved by employment of mechanisms for defining and monitoring forecast performance. Metrics of forecasting performance can be system specific in order to meet the needs of each individual application. Further, the particle ensemble, which is responsible for achieving the system forecast, is adaptable. Consequently, particles can be added or removed so that measured performance matches the performance demanded by an application. Ensemble enhancements, or particle addition, are based on rigorous statistical principles and undertaken when a platform is observed to underperform. Ensemble reduction, or particle removal, is optional and undertaken when current performance exceeds set requirements in the interest of being computationally efficient.

With respect to particle enhancement, particles can be added one particle at a time. This enables an error gap in forecasting to be closed and optimizes the size of an ensemble. However, the particle at a time approach can require significant time and computing effort. Alternatively, particle enhancements can employ batches to reduce time and computing effort. An optimal batch size can be computed based on needed reduction in error variance and sensitivity of the variance to change in ensemble discrepancy. Further, global optimization techniques can be employed to rapidly identify optimal particles to fill a batch of the size determined. Furthermore, a global optimization technique can be distributed across multiple threads or processors for simultaneous parallel processing.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

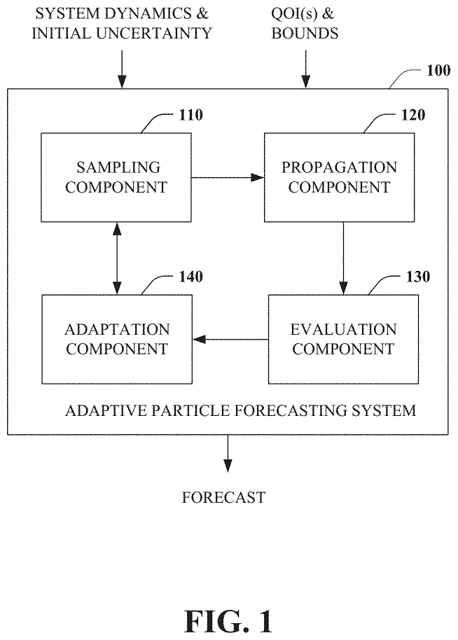

Referring initially to FIG. 1, an adaptive particle forecasting system 100. The system 100 is configured to employ known or novel particle filtering methods to generate a forecast, prediction, prognostic, or the like based on provided system dynamics that model behavior of systems, including complex systems. For example, system dynamics can provide a model of a particular jet engine that the system 100 can utilized to identify when a jet engine should be taken off an aircraft for service. Here, the prediction can be specific to one type of engine rather than historical data regarding engines in general.

More specifically, system dynamics provide the rules with which state of a dynamic system (e.g. a mathematical model of a physical process being studied) evolves with time. In one implementation, the state of the system can be defined in terms of a list of variables that describe the condition, or literally, the state, of the process. In addition, a rule of time evolution can be defined for each state.

The state can be denoted as “xₜ,” where the subscript “t” indicates time of specification. Thus, “x₀” indicates the system state at time “t=0.” The state need not be a scalar variable, but invariably can be a list of several variables. In other words, the state can be represented as a vector variable. In general, there may be “N” variables needed to specify the system condition, which can be written as xₜ=(xₜ₁, xₜ₂, . . . , xₜₙ)∈ [symbol] ^{N}. In other words, the state at time “t” is an element of the N-dimensional space of real numbers.

The rule of time evolution is represented by the symbol “Φₜ(⋅),” which represents a transition map that transfers a fixed initial state to its current value. In mathematical form, “xₜ=Φₜ(x₀).” This represents a general setup. It is possible for the map “Φₜ” to represent deterministic, stochastic, discrete, continuous, or even black-box type of models. Given a physical process, the map “Φₜ” is a mathematical model for the physical laws that govern evolution of state.

Given various sources of uncertainty in systems modeling, the state of the dynamic system (“xₜ”) is not a deterministic entity. Instead, it is a “random” (probabilistic) entity. Technically speaking, it is a stochastic process, which is characterized by its time varying probability density function (PDF), “Wₜ(x).” It is assumed that some estimate of the initial state of system uncertainty is available as input. Of course, the state PDF at all future times, “t>0,” denoted by “Wₜ(x) is unknown and is the central object of investigation. That is because metrics and parameters of interest involving the state of a dynamic system require knowledge of the PDF, “Wₜ(x).”

The system 100 also receives as input a quantity of interest (QoI) and accuracy bounds, which can be unique to each target application. The QoI may be a single function or a combination of functions that is central to a decision process the system 100 is to support. Prescription of accuracy can be particularly significant because individuals relying on a prediction want to have confidence that the prediction is accurate so they can make sound decisions based on the prediction. To determine the QoI and accuracy bounds, a user may answer the following question: “What parameters do I intend to measure in a system and how accurately must they be measured?” For example, in the prior jet engine example, the QoI could be probability of incidence of combustion instability with low accuracy bound of ninety percent and a high bound of ninety-five percent. Other examples of QoI in other contexts include remaining useful life of an electric car battery or probability of collision of space debris with a satellite.

More technically, each application has its key target parameters that are estimated during a forecasting process. These parameters support decision making or system prognostics and are desired to be estimated within specific thresholds of accuracy. These parameters are referred to as QoI. In general, they are a function of the random state, denoted by “h̅(xₜ)” here: “h̅(xₜ) [symbol] [symbol] _{w}_{ₜ}, [h(xₜ)]=∫_{Ω}_{ₜ}h(xₜ wₜ(x)dxₜ,” wherein the left side of the equal sign corresponds to the quantity of interest or QoI.

An application can involve one or many QoIs. The system 100 has the ability to intake as many QoIs as needed. In addition to each QoI, one needs to specify how accurately it must be estimated. In one instance, this can be given in terms of both upper and lower bounds on estimation error. The upper bound is denoted as “εₜ^{U}*” The lower bound is denoted as “εₜ^{L}*” The lower bound can be specified to generate the minimal sized particle ensemble that delivers requisite accuracy in estimation of QoI, “h̅.” The system 100 can maintain the measured QoI estimation error to be less than “εₜ^{U}*” and greater than “εₜ^{L}*” at all times. That is “εₜ^{L}*≤εₜⁿ≤εₜ^{U},” in which “εₜⁿ” represents the current QoI estimation error. The system 100 can be said to be underperforming when “εₜⁿ>εₜ^{U}*” and overperforming when “εₜⁿ<εₜ^{L}*.”

The system 100 provides guaranteed estimation accuracy of specific quantities of interest over the duration of a forecast. As a result, guesswork in determining a course of evolution of complex physical processes can be eliminated, which is invaluable for field agents (e.g., human, or robotic), decision makers, and designers, among others.

The system 100 provides closed-loop adaptive particle forecasting to deliver guaranteed accuracy in estimation of system quantities of interest. The system 100 can provide forecasting action that takes place using so-called “stochastic discretization” by way of a particle ensemble followed by its time propagation through system dynamics. The propagated ensemble aims to approximately quantify the system-state's true time-varying uncertainty, knowledge of which unravels further crucial statistics that achieve prognostics and support decision making.

To the extent that the system 100 uses particles to represent system uncertainty, the system can be considered a Monte Carlo platform. However, existing Monte Carlo forecasting methods are “open-loop” in the sense that following initial stochastic discretization, the user is bound to use the same particles for all future times. It can be shown that open-loop Monte Carlo systems cannot provide guarantees of how well the propagated ensemble captures future state uncertainty and they are not adaptive at all. Rather, such systems run, and when they reach the end, the result is evaluated and performed again with a different size particle ensemble.

As shown, the system 100 includes four components, namely sampling component 110, propagation component 120, evaluation component 130, and adaptation component 140. The sampling component 110 creates an ensemble representation of a given probability density function. The ensemble corresponds to a set of particles, or in other words, a set of samples used to capture evolution of state of a system. Sampling refers to an act of creating a particle. If sampling is performed once, one particle is created. If an ensemble has 50,000 particles, sampling has been performed 50,000 times. In other words, sampling is performed to create or enhance an ensemble. Each particle is a member of the ensemble, and together all particles comprise the ensemble. Further, the ensemble, as a whole, characterizes the state of a system.

The sampling component 110 is configured to employ an efficient sampling design. In order to be optimally efficient, the ensemble possesses a space-filling property and non-collapsing property. A sequential approach is employed wherein a single particle is chosen at random and additional particles are added such that at any point in the process the ensemble built maximizes both space-filling and non-collapsing criteria.

The system 100 can be based on core principles of Monte Carlo uncertainty quantification. Consequently, the state PDF at all times, namely “Wₜ(x)” is characterized using an ensemble of particles. This is written as “Pₜⁿ{xₜ¹, xₜ², . . . xₜⁿ}={xₜⁱ}ᵢ₌₁ⁿ˜Wₜ(x),” where the notation “Pₜⁿ” stands for the particle ensemble at time “t” including “n” particles, “xₜ¹, xₜ², . . . xₜⁿ.” This set characterizes the PDF, “Wₜ(x),” and is intended to be used as a surrogate for “Wₜ(x),” in instances where “Wₜ(x)” is needed, for example, in the evaluation of QoI. In essence, the objective is to determine the optimal “Pₜⁿ” that is able to estimate the application specific QoI within prescribed bounds of accuracy.

The sampling component 110 is configured to create an ensemble representation of a given PDF. In the present context, solely the initial state “W₀” is known. Most existing Monte Carlo simulation platforms employ a so-called Basic Random Sampler (BRS) to generate an initial ensemble. In BRS, samples are first drawn from a uniform distribution in an N-dimensional hypercube “ [symbol] ^{N}∈(0,1]^{N},” denoted as “ [symbol] (0,1]^{N}.” Then, each particle is transformed (e.g., by way of an inverse transform if the cumulative distribution function of the initial state is known) in order to represent the actual initial state PDF. Typically, BRS utilizes a pseudo-random number generator that does not optimally spread out over the domain of interest “( [symbol] ^{N}),” and therefore it does not guarantee that the subsequently transformed ensemble will represent the initial state PDF with sufficient accuracy.

The sampling approach by the sampling component 110 is an efficient sampling design. Without loss of generality, for purpose of the current discussion, assume that the initial state PDF is a uniform distribution “ [symbol] (0,1]^{N}.” In order for samples representing this uniform distribution to be optimally efficient, the ensemble needs to possess the so-called space-filling property and non-collapsing property.

A space-filling sample design leads to particles that fill out the domain of concern, in this case “ [symbol] ^{N},” as homogeneously as possible. While several metrics can be used to quantify this property, the default setting can be to use discrepancy to characterize the space filling nature of an ensemble. The centered L2-discrepancy can be used, which has the property of being invariant under reflections of “Pⁿ” about any plane “xⱼ=0.5” and is defined as follows:

$${𝒟}_{{CL}_{2}} ( {P}^{n} ) {\{ {\sum }_{u \neq 0} {\int }_{{C}^{u}} {\vert \frac{\# ( {P}_{u} , {J}_{{X}_{u}} )}{n} - Vol ( {J}_{{X}_{u}} ) \vert}^{p} dX \}}^{1 / p} ,$$

where “u” is a nonempty subset of the set of coordinate indices “Z={1, 2, . . . , N}, |u|” denotes the number of elements of “u,” “ [symbol] ^{u}” is a unit cube in the “|u|” dimensional space, and “Jₓ” is an N-dimensional hypercuboidal volume built by placing the particle “x” and the center of “ [symbol] ^{u}” at the ends of the diagonal, “Pᵤ” is the projection of “Pⁿ” to “ [symbol] ^{u},” and “Jₓ_{ᵤ}” is the projection of “Jₓ” on “ [symbol] ^{u}.” A more numerically amendable version of “D_{CL}_{₂}” exists, given

$${𝒟}_{{CL}_{2}}^{2} ( {P}^{n} ) = {( \frac{13}{12} )}^{𝒩} - \frac{2}{n} {\sum }_{k = 1}^{n} {\prod }_{i = 1}^{N} ( 1 + \frac{1}{2} \vert {x}_{ki} - 0.5 \vert - \frac{1}{2} {\vert {x}_{ki} - 0.5 \vert}^{2} ) + \frac{1}{{n}^{2}} {\sum }_{k = 1}^{n} {\sum }_{l = 1}^{n} {\prod }_{i = 1}^{N} [ 1 + \frac{1}{2} \vert {x}_{ki} - 0.5 \vert + \frac{1}{2} \vert {x}_{li} - 0.5 \vert - \frac{1}{2} \vert {x}_{ki} - {x}_{li} \vert ] .$$

An efficient sampling design can also possess good projective properties, also known as the non-collapsing property. It stipulates that for every point “xᵢ, (i=1, . . . , n)” in a sampling design “Pⁿ,” the numerical value of each coordinate of each point xᵢ_{ⱼ} (j=1, . . . , N)” is strictly unique. In other words, when the sampling design is projected onto a lower dimensional space, for example from N-dimensional to a (N−1)-dimensional space, no pair of particles are superposed or too close to each other as defined by an appropriate threshold. The non-collapsing property can be defined in terms of the minimum projected distance of points from each other as follows:

$${‖ P ‖}_{- ∞} = {min}_{{x}_{i} , {x}_{j} ∈ P} {min}_{1 \leq k \leq N} \vert {x}_{{i}_{k}} - {x}_{{j}_{k}} \vert = {min}_{{x}_{i} , {x}_{j} ∈ P} {‖ {x}_{i} - {x}_{j} ‖}_{- ∞} ,$$

where “∥x∥_{-∞}” presents the minus infinity norm.

The space-filling property and the non-collapsing property can be optimized in a layered manner by the sampling component 110. A sequential approach can be adopted that starts with a single particle chosen at random and then sequentially adds additional particles such that at any point the ensemble built thus far maximizes both the space-filling and non-collapsing criteria. Thus, the sampling component 110 can be deemed a sequential sampler because generation of each new optimal particle depends on the current, existing ensemble.

The propagation component 120 employs a suite of evolution processes dependent on the nature of an underlying dynamic system. In general, the objective of the propagation component 120 is to determine a system map such that for each initial particle a propagated particle is given.

The propagation component 120 can employ a suite of particle evolution algorithms, depending on the nature of the underlying dynamic system. For example, if the system evolution model is a system of ordinary differential equations (ODEs), a Runge-Kutta integration scheme can be used. Similarly, if the physics is described using stochastic differential equations, an Euler integration scheme (or other higher order scheme) can be employed. The general object is to determine the system map “Φₜ(.)” such that for each initial particle “x₀^{j},” the propagated particle can be given as “xₜ^{j}=Φₜ(x₀^{j}).”

In addition to propagating each particle, when possible, it may be required to propagate the PDF value with this particle. This can be used when particles are removed. When it is determined that the ensemble needs to be downsized, particles can be selected for removal on the basis of their significance (weightage) to the current ensemble. Particles with lower weights (e.g., those in the tail region) exert less influence on the current probability distribution (include less information) and are considered for removal with greater probability. The weight of the particle is assumed to be the value of the PDF evaluated at its current location. When system dynamics is given by ordinary differential equations (ODEs), state PDF at a particle location can be obtained by propagating the so-called stochastic Liouville equation (SLE), which is a first order quasi-linear partial differential equation (PDE):

$$\frac{\partial }{\partial t} 𝒲 ( t , x ) = {ℒ}_{SL} [ 𝒲 ( t , x ) ] = - {\sum }_{i = 1}^{N} \frac{\partial }{\partial {x}_{i}} ( {f}_{i} {𝒲}_{t} ) = - {\sum }_{i = 1}^{N} ( {f}_{i} \frac{\partial {𝒲}_{t}}{\partial {x}_{i}} + {𝒲}_{t} \frac{\partial {f}_{i}}{\partial {x}_{i}} ) ,$$

where “ [symbol] _{SL}” is the stochastic Liouville operator. Again, in the case of ODE system dynamics, the trajectory of each particle in the ensemble is already available from their forward propagation. The method of characteristics (MOC) can thus be conveniently used to compute the solution of the SLE at its current location in the state-space at the current time. In MOC, a first-order quasi-linear partial differential equation, such as the one above, can be transformed to a set of ODEs along so-called characteristic manifolds. The characteristic manifold of SLE is nothing but the system trajectory, which is already available. The ODE governing the evolution of state-PDF for each particle is given as

$$\frac{d}{dx} 𝒲 ( t , x ) = - 𝒲 ( t , x ) \cdot ∇ \cdot f ( t , x ) ,$$

which solves out to give:

$$𝒲 ( t , x ( t ) ) = {𝒲}_{0} [ {x}_{0} ( x ( t ) ) ] exp [ - {\int }_{{t}_{0}}^{t} ∇ \cdot f ( τ , {x}_{c} ( τ ) ) d τ ] ,$$

where “x₀[x(t)]” is the initial condition corresponding to the particle's current location x(t), which is known, and “∇·f” is the divergence of the dynamic system. The path integral in the above equation is trivial because the particle's trajectory is available in most cases, which reduces to a straight-forward summation.

The evaluation component 130 evaluates the performance of the system. The first step toward constructing an adaptable ensemble is a definition of metrics that quantify its transient performance. To this end, a quantity of interest (QoI) is defined as the expected value of an application appropriate function of the state “h(xₜ),” where “xₜ” is the current state with density function “ [symbol] (xₜ)≡ [symbol] ₜ,

$$\underbrace{\overline{h} ( {x}_{t} ) {=}^{Δ} {𝔼}_{{𝒲}_{t}} [ h ( {x}_{t} ) ]}_{Quantity of Interest : QoI} = {\int }_{{Ω}_{t}} h ( {x}_{t} ) {𝒲}_{t} {dx}_{t} ,$$

where “Ωₜ” is the state space at time “t.” Assuming the state transition map “Φₜ(x₀)=xₜ” is injective and continuously differentiable, the above equation can be transformed such that the integral is expressed in terms of the associated initial state PDF,

$${𝔼}_{{𝒲}_{t}} [ h ( {x}_{t} ) ] = {\int }_{{Ω}_{t}} h ( {x}_{t} ) {𝒲}_{t} {dx}_{t} = {\int }_{{Ω}_{0}} h [ {Φ}_{t} ( {x}_{0} ) ] {𝒲}_{t} \underbrace{\vert det ( D {Φ}_{t} ) ( {x}_{0} ) \vert {dx}_{0}}_{{dx}_{t}} = {\int }_{{Ω}_{0}} h [ {Φ}_{t} ( {x}_{0} ) ] \underbrace{{𝒲}_{0} \vert det ( D {Φ}_{t}^{- 1} ) \vert}_{{𝒲}_{t}} \vert det ( D {Φ}_{t} ) \vert {dx}_{0} = {\int }_{{Ω}_{0}} h [ {Φ}_{t} ( {x}_{0} ) ] {𝒲}_{0} \frac{1}{\vert det ( D {Φ}_{t} ) \vert} \vert det ( D {Φ}_{t} ) \vert {dx}_{0} = {\int }_{{Ω}_{0}} \underbrace{h [ {Φ}_{t} ( {x}_{0} ) ]}_{{S}_{t} ( {x}_{0} )} {𝒲}_{0} {dx}_{0} = {𝔼}_{{𝒲}_{0}} [ {S}_{t} ( {x}_{0} ) ] ,$$

where “Ω₀” is the domain of integration (the “state space”) at time “t₀.” “|det(DΦₜ)(x₀)|” is the determinant of the Jacobian matrix of the partial derivatives of the function “Φₜ(x₀).” “Φₜ⁻¹” represents the inverse of “Φₜ,” and it maps a give point in the state-space at time “t” to its associated initial condition (i.e., “Φₜ⁻¹(x)=x₀,” such that “Φₜ(x₀)=x”). Finally, “sₜ(⋅) [symbol] (h∘Φₜ)(⋅)=h[Φₜ(⋅)]” is a composite function and assumed to be integrable. The actual form of the function “h(⋅)” is intended to be application dependent. For example, if “h(xₜ)=xₜ,” then “Sₜ=xₜ” and the QoI represents the evolved mean of the state.

The Monte Carlo (MC) estimate of the QoI using the current (propagated) ensemble, “{(Φₜ(xₙⁱ)}ᵢ₌₁ⁿ,” is simply the sample mean:

$${𝔼}_{{𝒲}_{t}} [ h ( {x}_{t} ) ] \approx {\tilde{h}}_{n} = \frac{1}{n} {\sum }_{i = 1}^{n} h ( {x}_{t}^{i} ) {=}^{Eq . ( 18 )} \frac{1}{n} {\sum }_{i = 1}^{n} {S}_{t} ( {x}_{0}^{i} ) .$$

When “ [symbol] [h(xₜ)]” exists, the weak law of large numbers states that for all small “ξ>0, lim_{n→∞}Pr(|h̅−\tilde{h}ₙ|>ξ)=0,” which in turn predicates the following statements: (i) the MC approximation of the QoI, that is, “\tilde{h}ₙ” is an unbiased estimate of h̅(xₜ)= [symbol] [h(xₜ)];” and (ii) the larger the sample size (“n”), the smaller the probability (“P(⋅)”), that “\tilde{h}ₙ” differs from the truth “ [symbol] [h(xₜ)]”). Furthermore, the central limit theorem (CLT) provides insight into the weak convergence of the error, “εₙ [symbol] (h̅−\tilde{h})” in the MC estimate the QoI:

$${ɛ}_{n} = ( \overline{h} - {\tilde{h}}_{n} ) {\to }^{d} 𝒩 ( 0 , \frac{{σ}^{2}}{n} ) ,$$

as “n→∞,” where “σ²=σ² (h(xₜ))” is the variance of the function “h(xₜ)” of concern. The true value of this statistic is of course unknown. Transformation allows us to write “σ²(h(xₜ))=σ²(Sₜ(x₀)).” Assuming that the state “xₜ” has finite variance, the result is:

$${σ}^{2} = {σ}^{2} ( h ( {x}_{t} ) ) = {\int }_{{Ω}_{t}} {( h ( {x}_{t} ) - \overline{h} )}^{2} {dx}_{t} = {σ}^{2} ( {S}_{t} ( {x}_{0} ) ) = {\int }_{{Ω}_{0}} {( {S}_{t} ( {x}_{0} ) - \overline{h} )}^{2} {dx}_{0} .$$

Now the MC estimate of QoI formula provides the following limiting behavior of the standard deviation of the MC approximation error in terms of the QoI (“σ_{ε}_{ₙ}”):

$$\underbrace{{σ}_{{ɛ}_{n}}}_{Performance measure} = \sqrt{𝔼 [ {( \overline{h} ( {x}_{t} ) - {\tilde{h}}_{n} ( {x}_{t} ) )}^{2} ]} = \sqrt{𝔼 [ {ɛ}_{n}^{2} ]} {\to }_{Eqs . ( 20 ) , ( 21 )} \frac{σ ( {S}_{t} ( {x}_{0} ) )}{\sqrt{n}} ,$$

as “n→∞.” Clearly, “σ_{ε}_{ₙ}” quantifies the departure of the MC approximation (“\tilde{h}ₙ”) from the truth (“h̅”) in direct terms of the quantity of interest. Therefore, the adaptive system 100, by way of the evaluation component 130, uses it as the quantitative measure of transient MC performance.

The performance metric was defined above in terms of the standard deviation of the error, “σ_{ε}_{ₙ}” in the ensemble estimate of an application appropriate quantity of interest (QoI), “h(xₜ).” The users need not limit themselves to a single QoI. Multiple separate QoIs can be defined with separate error thresholds on each individual metric, or single composite performance metric can also be defined with multiple QoI included within after appropriate normalization. As an example of the latter, consider there are multiple QoIs, “h̅ₖ̅, k=1, . . . , K.” In this scenario, the composite error metric becomes:

$${ɛ}_{t}^{n} = \sqrt{\frac{{\sum }_{k = 1}^{K} {σ}_{t}^{2} ( {h}_{k} )}{Kn}} ,$$

where “σₜ²(hₖ)” represents the variance of each QoI function “hₖ(xₜ)” at time “t.” The quantity “εₜⁿ” cannot be computed directly due to the unknown true state. The evaluation component 130 can employ a bootstrap method, which is often used to approximate the distribution of a function “Gₜ” of samples “({xₜⁱ}ₙ₌₁ⁿ)” in terms of the so-called bootstrap distribution. Let “{xₜ¹, xₜ², . . . , xₜⁿ}” be the available sample set of size “n” at time “t” with the true distribution “ [symbol] ₜ,” and let “G(xₜ¹, xₜ², . . . , xₜⁿ; [symbol] ₜ)=Gₜ(xₜ¹, xₜ², . . . , xₜⁿ; [symbol] )” be the function of concern (also random variable). In our case, Gₜ(xₜ¹, xₜ², . . . , xₜⁿ; Wₜ)=(h̅− [symbol] )ₜ.” This is the MC estimation error. Consider “ [symbol] ₜⁿ,” which is the empirical distribution function of the samples (i.e., “{xₜⁱ}ᵢ₌₁ⁿ”), obtained by assigning to each sample “xₜ¹, xₜ², . . . , xₜⁿ,” an equal probability mass of “1/n.” Then the bootstrap method approximates the distribution of Gₜ(x¹, x², . . . , xⁿ; Wₜ)” by the so-called “bootstrap-distribution” under “ [symbol] ₜⁿ.” That is, “Gₜ(y¹, y², . . . , yⁿ; [symbol] ₜⁿ)” where “{yₜ¹, yₜ², . . . , yₜⁿ}” is a new ensemble of the same size “n,” generated by resampling with replacement from the empirical distribution “ [symbol] ₜⁿ.” Therefore, we have “ [symbol] ₜ(\tilde{h}ₙ−\tilde{h}ₙ*)→ [symbol] ₜ(h̅−\tilde{h}ₙ),” where

$$“ {\tilde{h}}_{n} = \frac{{\sum }_{i = 1}^{n} h ( {x}_{t}^{i} )}{n} , {\tilde{h}}_{n}^{*} = \frac{{\sum }_{i = 1}^{n} h ( {y}_{t}^{i} )}{n} ”$$

and “h̅” is the unknown true value of the quantity of interest, and “ [symbol] ₜ(\tilde{h}ₙ−\tilde{h}ₙ*)” representing the bootstrap distribution approximating “ [symbol] ₜ(h̅−\tilde{h}ₙ).”

Suppose bootstrap sampling is performed at total of “L” times, resulting in “L” ensembles “{yₜ¹, yₜ², . . . , yₜⁿ}ₗ, l=1, . . . , L” and “L” corresponding approximations of the QoI, labeled “hₙ^{l}:”

$${\tilde{h}}_{n}^{l} = \frac{{\sum }_{i = 1}^{n} h ( {y}_{{t}_{l}}^{i} )}{n} , l = 1 , … L$$

To finish the MC performance is quantified in terms of the standard deviation of the bootstrap estimates:

$${ɛ}_{t}^{n} = ɛ ( {P}_{t}^{n} ) = \frac{σ ( {\tilde{h}}_{n}^{*} )}{\sqrt{n}}$$

The adaptation component 140 is invoked whenever the evaluation component 130 determines that a system is underperforming or, optionally, overperforming. The loop on particle forecasting is closed by comparing the measured performance with what is prescribed. If the measured gap lies outside thresholds of tolerance, ensemble adaptations are initiated by the adaptation component 140 until the gap is closed. The process repeats as the forecast carries on. The core principle behind ensemble adaptations is based on the so-called Koksma-Hllawka inequality, from which it is inferred that the current performance of the particle ensemble can be controlled by modifying the quality of the ensemble. There are two possible scenarios, namely the current ensemble is underperforming or overperforming.

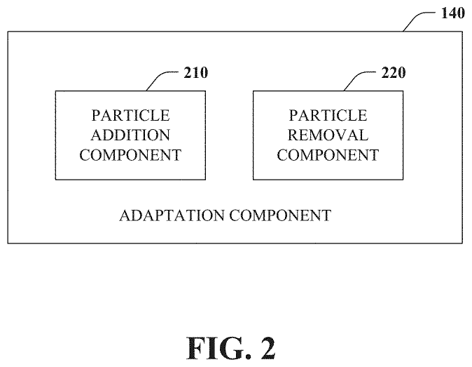

Turning attention to FIG. 2, a sample adaptation component 140 including particle addition component 210 and particle removal component 220. The particle addition component 210 introduces new particles in batches until the performance of the system is once again within a prescribed threshold. The particle removal component 220 addresses a system that is overperforming by removing particles in batches until the system is again within the prescribed threshold. The particles selected for removal can, in one embodiment, be halted and remain available to be re-invoked in the future, if needed.

If the current ensemble is underperforming, the measured accuracy is less than the prescribed accuracy by an amount greater than the set tolerance. In this case, the particle addition component 210 formulates and solves an optimization problem that seeks to maximize the efficiency of the particle ensemble at the initial time. This can be done sequentially by adding particles that maximize ensemble efficiency measured in terms of space-filling and non-collapsing attributes of the ensemble. The space-filling property is characterized by one of many possible metrics, depending on application, including discrepancy, Audze-Eglais criterion, or maximum criterion, among others. The non-collapsing property is characterized in terms of minimum projective distance of the ensemble, implemented in two different ways, depending on the dimensionality of the underlying state space. Each particle added to the initial ensemble is then forward propagated to meet the current ensemble. Particle addition can continue until the measured performance of the enhanced ensemble reaches the prescribed level. In accordance with one embodiment, particles can be added as batches rather than one at a time as described later herein.

The current ensemble is overperforming if the measured accuracy is greater than the prescribed accuracy by an amount greater that a set tolerance. Although this sounds counterintuitive, it is indeed possible and can be shown to be true. In essence, under these circumstances, the current ensemble is providing accuracy greater than is necessary and there is a case to be made for downsizing the existing ensemble in the interest of saving computational effort. If computational burden is not a significant concern in a particular application, this can be skipped. If, however, each particle entails a measurable computational burden, as is true for many complex systems, the new platform provides a rigorous approach for shedding unnecessary burden while maintaining QoI estimation performance within set bounds. Each particle in the current ensemble is subject to removal with a probability of removal inversely related to its significance to the current ensemble. The significance of each particle to the ensemble is measured by solving the so-called stochastic Liouville equation associated with underlying dynamics along characteristic lines, which turn out to be the computed trajectory of the various particles. Once enough particles are identified for removal from the ensemble to bring MC performance within specified bounds, forecasting is allowed to continue again. The particles selected for removal can be frozen in time so that if they are needed again at a future enrichment step, they are available with minimal additional computations.

The particle addition component 210 will now be described in further technical detail. A cardinal feature of the system 100 is its ability to adapt its time evolving ensemble, “Pₜⁿ” to ensure that its measured performance, “εₜⁿ,” falls within prescribed performance thresholds as previously stated, namely “εₜ^{L}*≤εₜⁿ≤εₜ^{U},” in which “εₜⁿ” represents the current QoI estimation error corresponding to the ensemble “Pₜⁿ” of “n” particles. Also, “εₜ^{U}*” and “εₜ^{L}*” represent the lower and upper bounds, respectively, on measured error. The system 100 is underperforming when “εₜⁿ>εₜ^{U}*” and overperforming when “εₜⁿ<ₜ^{L}*.”

When the system 100 is underperforming, new particles are introduced in batches of “B” particles until the MC accuracy is once again within the prescribed threshold. All new particles are added to the initial ensemble “Pₜ_{₀}ⁿ” at time “t₀,” and then forward propagated to join the ensemble at the current time. More specifically, “Pₜⁿ→Pₜⁿ∪ᵢ₌₁^{B}Φₜ(x₀*ⁱ),” where “x₀*ⁱ” is the i^{th} “B” can be defined by a user to be as low as one. The core principles of particle addition can be the same as those with respect to efficient sampling as previously described. It is formulated in terms of optimization of sample efficiency of the associated initial ensemble, which is characterized by space-filling and non-collapsing properties. The former is quantified in terms of the centered L₂-discrepancy and the later in terms of minimum projective distance. The following optimization problem with a composite cost involving these to metrics results:

$${x}_{0}^{*} = arg {min}_{{x}_{j}^{c} ∈ {C}^{N}} ℛ ( {P}_{{t}_{0} , j}^{p + 1} ) = arg {min}_{{x}_{j}^{c} ∈ {C}^{N}} [ {𝒟}_{{CL}_{2}}^{2} ( {P}_{{t}_{0} , j}^{p + 1} ) - {min}_{{x}_{i} ∈ {P}_{{t}_{0}}^{p}} {‖ {x}_{i} - {x}_{j}^{c} ‖}_{- ∞} ] ,$$

where “x₀*” is the single new optimal particle that minimizes the score “ [symbol] ” and is to be added to the initial ensemble “Pₜ_{₀}^{p},” resulting in the augmentation, “Pₜ_{₀}ₙ₊₁=Pₜ_{₀}^{p}∪x₀*.” The optimization can be done in a two-tiered approach, with a different set of rules for low dimensional (“N≤6”) and high dimensional (“N>6”) scenarios. Particle addition can continue in batches of “B” particles at-a-time until the estimated error of the enhanced ensemble falls within prescribed thresholds.

The particle removal component 220 is now considered in further technical detail. The system 100 can set guidelines for both underperformance and overperformance. The system 100 is said to be overperforming when “εₜⁿ<εₜ^{L}*.” The particle removal component 220 is concerned with this situation. In such an event, an ensemble thinning can be carried out in the interest of alleviating computation load. This is optional and makes sense when the underlying dynamic system is complex. The question is how to select particles to remove from an existing ensemble while preserving not only the characteristics of the current state-uncertainty, but also the sampling efficiency. The particles chosen for removal need only be halted and are available to be re-invoked, if needed again in the future.

The method for identifying candidates for removal based on their current significance (e.g., weightage) to the ensemble. As mentioned before, the weight of a particle “xₜ^{j}” is assumed to be the value of the PDF evaluated at its current location, namely “ [symbol] ₜ(xₜ^{j}).” For dynamic systems governed by ODEs, this can be estimated by solving the underlying stochastic Liouville equation (SLE). Each member particle of the current ensemble, no matter how high its associated weightage is a candidate for removal. Consider the current ensemble, “Pₜⁿ={xₜ¹, . . . , xₜⁿ}.” The probability of removal of member particle “xₜ^{j}” from the ensemble can be given as

$$Pr ( Remove {x}_{t}^{j} ) = 1 - \frac{𝒲 ( t , {x}_{t}^{j} )}{{\sum }_{i = 1}^{p} 𝒲 ( t , {x}_{t}^{i} )}$$

Like particle addition, particle removal can also occur in batches of “B” particles at a time. “B” particles are removed at a time using the probability of removal of each individual particle. The process of removing “B” particles at a time continues in a sequential manner until the measured error is raised above the specified lower bound, namely “εₜⁿ>ₜ^{U}*.”

An intelligent approach to determine optimal batch size can be employed when the particle addition component 210 is activated. Particles can be introduced in a single shot, thereby minimizing the amount of computing effort needed for ensemble enhancement. After a first few iterations, batch enhancements can be performed. This can begin with maintaining the sensitivity of the variance of QoI error to the change in ensemble discrepancy. Similarly, sensitivity of the ensemble discrepancy to batch size can be maintained. In mathematical terms, these can be written as

$$“ {σ}_{v 𝒟} = \frac{δ v}{δ 𝒟} ” and “ {σ}_{𝒟 ɛ} = \frac{δ 𝒟}{δ ɛ} ”$$

where “v,” “ [symbol] ,” and “ε” represent error variance, discrepancy, and ensemble size, respectively. “δ” denotes change. Therefore, “δε” represents batch size. When the performance evaluation component 130 identifies a need for particle addition, the batch can be estimated as:

$$“ Δ E = Δ v \times \frac{1}{{σ}_{v 𝒟}} \times \frac{1}{{σ}_{𝒟 ɛ}} \times 𝒦 ( E ) . ”$$

in this equation, “Δv” is the needed reduction in error-variance. “σ_{vD}” and “σ [symbol] _{ε}” are sensitivities defined above. Finally, “ [symbol] (E)” is a correction term (e.g., an exponential function) that corrects the sensitivities for the current size of the ensemble, because the moment where the correction is needed is not the same as the moment when the sensitivities are computed. Such optimization of the batch size can provide a significant reduction in run time especially with respect to complex problems because the problem scales rapidly in complex settings, making benefits of optimal batch update even more impactful.

Global optimization techniques can be utilized to rapidly identify optimal particles for ensemble enhancement by way of the particle addition component 210. In one instance, a parallel implementation of simulated annealing, a global optimization routine can be employed. In this approach, all optimal particles can be identified simultaneously for introduction into an ensemble for adaptation. This can begin by executing simulated annealing (SA) of the discrepancy function with respect to an existing ensemble, for instance by way of a parent thread. Once

“M” simulated annealing cycles of Markov chain construction are completed, the ending location of the chain can be declared as the terminal site of the parent thread. This allows a new discrepancy function to be defined, which is then further optimized by searching for a new optimal particle in a new compute-thread. Meanwhile, the parent thread continues to execute, ultimately terminating in an optimal location that minimizes the discrepancy with respect to the origin ensemble. This recursive structure can be spawned (B−1) times, where “B” is the desired size of the new batch. Each thread can be executed on a parallel processor. The ending location of each thread can be collected to result in the new batch to be introduced into the ensemble.

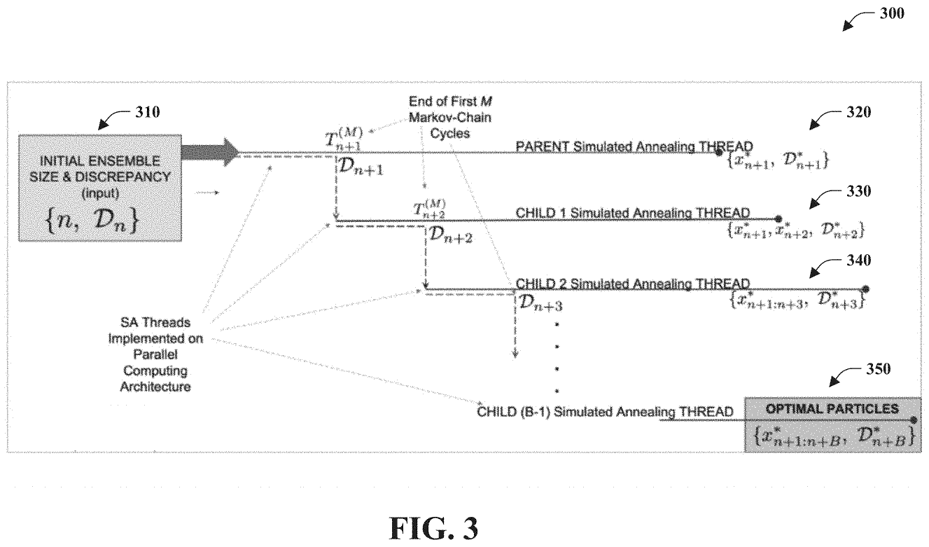

Turning attention to FIG. 3, a simulated annealing process 300 is shown. The simulated annealing process starts with an initial ensemble size and discrepancy as input “{n, [symbol] ₙ}.” A parent simulated annealing thread 320 is started. After the parent thread executes the first “M” Markov-chain cycles “Tₙ₊₁^{M},” a new discrepancy can be determined “ [symbol] ₙ₊₁” Child 1 simulated annealing thread 330 can subsequently be spawned to identify a particle based on the new discrepancy, “ [symbol] ₙ₊₁.” After the first “M” Markov-chain cycles, “Tₙ₊₂^{M},” another new discrepancy can be determined “ [symbol] ₙ₊₂.” Child 2 simulated annealing thread 340 can then be started to identify a particle based on the discrepancy “ [symbol] ₙ₊₂.” The process of creating a new discrepancy and spawning a new thread can continue until a target batch size is reached (e.g., “B−1” where “B” is the batch size). Each thread can execute until complete resulting in identification of an optimal particle, which collectively comprise optimal particles 350. In one instance, each of the simulated annealing threads, 320, 330, and 340 can be implemented on a parallel computing architecture to enable substantially simultaneous particle determination

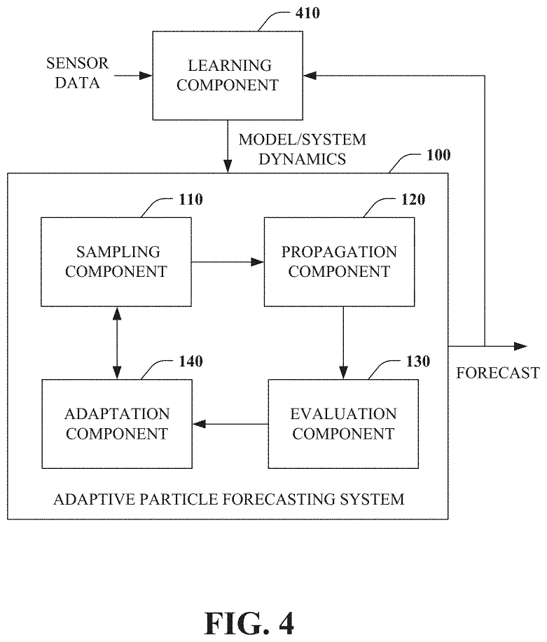

Turning to FIG. 4, the adaptive particle forecasting system 100 is illustrated. The system 100 includes sampling component 110, propagation component 120, evaluation component 130, and adaptation component 140, as previously described with respect to FIG. 1. In accordance with one implementation, physics-based models of dynamic systems can be provided as input and integrated within the system 100. For instance, in a prognostics problem involving prediction of jet-engine failure, a user can provide a physics-based model of flow around critical engine components. The system 100 acquires these models and performs uncertainty forecasting around them. However, there are many cases in which the physics-based models are not available. Learning component 410 can be employed to generate such models. The learning component 310 can acquire sensor data from a client and construct a system of evolution models in lieu of the aforementioned physics-based models. This can be beneficial with respect to manufacturing systems, drilling systems, and power-grid systems, among others. Nevertheless, there is a plethora of sensing technology readily available that can generate time-history data within a short period of time. Such data can be provided as input to the learning component 310, which can utilize deep neural network (DNN), reservoir neural networks (RNN), or other artificial intelligence-based techniques to construct surrogate models of dynamic systems. Further, an output forecast from the system 100 can be utilized as a source of information and could provide a feedback loop to facilitate learning of a new model by the learning component 410.

The aforementioned systems, architectures, platforms, environments, or the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull control model. The components may also interact with one or more other components not specifically described herein for sake of brevity, but known by those of skill in the art.

Various portions of the disclosed systems above and methods below can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, among others, can automate certain mechanisms or processes performed thereby to make portions of the systems and methods more adaptive as well as efficient and intelligent. By way of example, and not limitation, the learning component 410 can employ such techniques to develop model of dynamic systems for use in forecasting. Further, other components of system 100 can also employ such mechanisms, for instance in generating an optimal batch size for enhancing an ensemble, among other things.

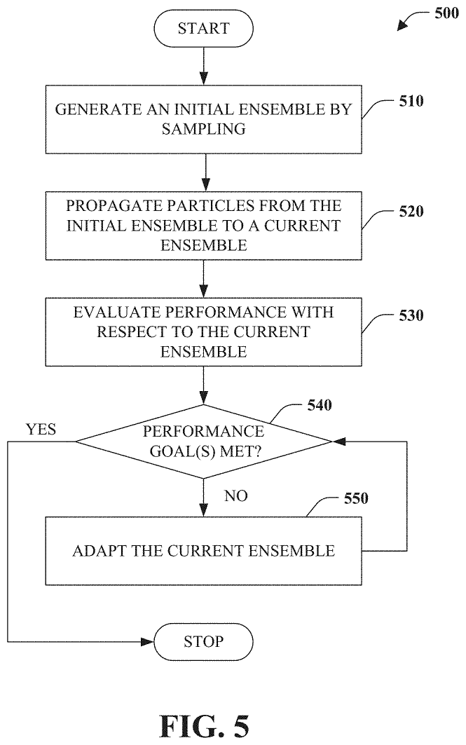

In view of the exemplary systems described above, methods that may be implemented in accordance with the disclosed subject matter will be better appreciated with reference to flow chart diagrams of FIGS. 5-9. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

FIG. 5 illustrates a method 500 of ensemble adaptation, which can be implemented by the system 100 and components thereof. At numeral 510, an initial ensemble is generated by sampling. The ensemble can correspond to a representation of a probability density function. In accordance with one implementation, the initial ensemble can be constructed by sequentially adding particles to the ensemble. To start a single particle can be selected at random followed by sequential addition of particles. Further, the additional particles can be selected and added to the initial ensemble such that at any point the ensemble built maximizes both space-filling and non-collapsing criteria.

At numeral 520, particles from the initial ensemble are propagated to a current ensemble. Given the initial ensemble and input regarding system dynamics, associated with a particular dynamic system, the particles are propagated in time to a current ensemble. Various particle evolution algorithms can be employed depending on the underlying dynamic system. For example, if the system evolution model is a system of ordinary differential equations (ODEs), a Runge-Kutta integration scheme can be used. Similarly, if the physics is described using stochastic differential equations, an Euler integration scheme (or other higher order scheme) can be employed. The general objective is to map each initial particle to a propagated particle.

At 530, performance is evaluated in the context of the current ensemble. Evaluation can be performed based on a specified quantity of interest (QoI) and error bounds associated with the QoI. The result of the performance evaluation is a current error.

At numeral 540, a determination is made as to whether or not a performance goal is met. The performance goal can be defined in terms of prescribed bounds associated with a quantity of interest. The current error produced as a result of evaluation can be employed to determine whether or not the performance goal is met. For example, if the current error is less than an upper bound on error and greater than a lower bound on error, the performance goal can be deemed met. By contrast, if the current error is greater than an upper bound or less than a lower bound, the performance goal can be deemed unmet. Of course, performance evaluation can be associated with more than one goal with respect to more than one quantity of interest, which can be met or unmet. If the performance goal is met (“YES”), the method 500 can simply terminate without further action. By contrast, if the performance goal is unmet (“NO”), the method can continue at 550. At numeral 550, the current ensemble can be adapted. For example, particles can be added or removed from the ensemble. Subsequently, the method 500 can loop back to 540 to check whether or not the adaptation resulted in the performance goal being met. If the performance goal is unmet (“NO”), method 500 can continue to loop to 540 until such time as the performance goal has been met.

In one instance, particles can be added to or removed from an ensemble one particle at a time. Performance can be evaluated after addition or removal of a single particle, resulting in an optimal size ensemble. However, this can be time consuming and intractable for complex scenarios. Accordingly, in an alternate approach, particle batches can be determined and either added or removed from an ensemble, wherein in a particle batch includes a particular number of particles.

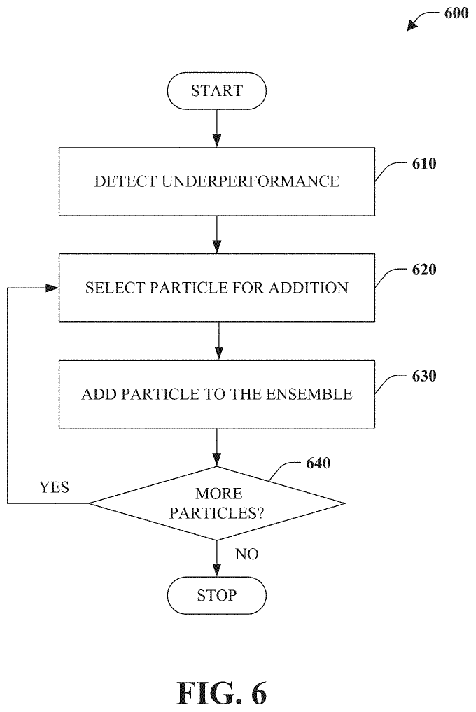

FIG. 6 depicts a method 600 of particle addition to enhance an ensemble. The method 600 can be performed by the system 100 and more particularly the adaption component 140. At numeral 610, underperformance can be detected. Underperformance can be detected when measured accuracy is less than prescribed accuracy. Stated differently, underperformance can be detected when current estimation error associated with a quantity of interest (QoI) is greater than a prescribed low threshold.

At numeral 620, particles are selected for addition to the current ensemble. Particles can be selected in terms of their space-filling and non-collapsing properties of the ensemble. The space-filling property can be characterized by one of many possible metrics depending on the application, including discrepancy, Audze-Eglais criterion, and maximum criterion, among others. The non-collapsing property is characterized in terms of minimum projective distance of the ensemble, implemented in different ways depending on the dimensionality of the underlying state space.

At 630, particles are added to the ensemble sequentially. Subsequently, a determination is made at 640 as to whether or not more particles should be added to the ensemble. The determination can be based on performance with respect to a quantity of interest in view of addition of the latest particle to the ensemble. If performance is not in line with a performance threshold, more particles will need to be added to enhance the ensemble and improve accuracy. Otherwise, if performance is in line with the performance threshold, no additional particles will need to be added. At 640, if more particles are unneeded (“NO”), the method 600 can simply terminate successfully. If more particles are needed (“YES”), the method loops back to 620 where a particle is selected for addition. The method 600 can continue to loop to add particles until performance is at a desired level.

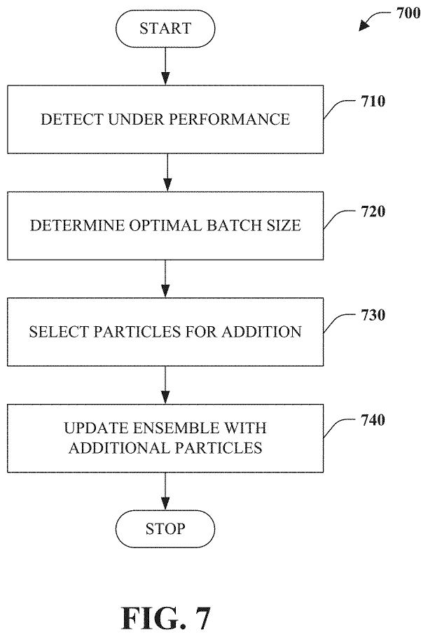

FIG. 7 illustrates a method 700 of particle addition to address underperformance. At numeral 710, underperformance is detected. For example, evaluation of performance of a quantity of interest (QoI) results in an estimation error that is larger than permitted based on comparison to a threshold.

At numeral 720, an optimal batch size is computed, wherein the batch represents a set of particles. The optimal batch size can be computed based on needed reduction in error variance, wherein the needed reduction corresponds to the amount the error needs to be reduced to be within a prescribed bound. Further, sensitivities can be considered including relationships between a change in variance versus a change in discrepancy, and a change in discrepancy versus a change in batch size. Discrepancy, the result of a discrepancy function, describes how closely a model conforms to observed data. In other words, discrepancy is a measure of goodness of fit. A correction term can also be introduced to correct for sensitivities for the current size of an ensemble.

At 730, particles are selected for addition. The number of particles can correspond to the optimal batch size previously computed. In accordance with one implementation, particles can be selected by executing simulated annealing (SA) of the discrepancy function associated with an existing ensemble. More specifically, particles can be selected that minimize the discrepancy with respect to the current ensemble. Further, a parallel implementation of simulated annealing can be employed. For instance, simulated annealing of the discrepancy function can be performed with respect to the existing ensemble. After a predetermined number of simulated annealing cycles of Markov chain construction are completed, the ending location of the chain is deemed the terminal site of the parent thread. A new discrepancy function can then be defined based on the terminal site of the parent thread, and a child thread is spawned to similarly identify another particle. Meanwhile, the parent thread continues to execute ultimately terminating at a location and particle that minimizes the discrepancy with respect to the existing ensemble. This recursive structure can be spawned “B−1” times where “B” is the batch size. Further each thread can be executed on a parallel processor. The ending location and particle of each comprise the batch of particles. The ensemble is updated with the additional set of particles in the batch at 740.

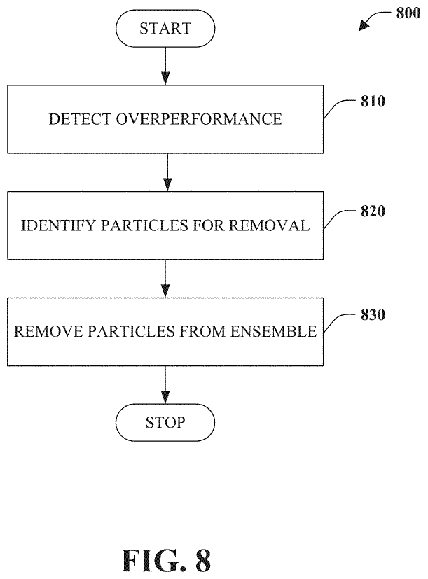

FIG. 8 depicts a method 800 of particle removal, which can be executed by the system 100 and more specifically the particle removal component 220. At reference numeral 810 overperformance is detected. Overperformance can occur when measured accuracy is greater than a set tolerance. Stated differently, current estimation error can be below a lower bound. In essence, the current ensemble is providing greater accuracy than necessary, and there is a case to be made for downsizing the existing ensemble in the interest of reducing computational burden. Each particle can be associated with a measurable computational burden, especially for many complex systems.

At reference numeral 820, particles can be identified for removal. Each particle in the current ensemble can be subject to removal, with probability of removal inversely related to its significance to the current ensemble. The significance of each particle to the ensemble can be measured by solving the stochastic Liouville equation associated with the underlying dynamics along characteristic lines, which turns out to be the computed trajectory of the various particles. Particles can continue to be identified for removal until enough are identified to bring performance within specified bounds.

At 830, the particles identified for removal are removed from the current ensemble. As a result, simulation execution time can be optimized with the least number of particles to deliver specified accuracy. In accordance with one embodiment, the particles selected for removal can be made unavailable but not removed completely. In this manner, if the particles are needed again for a future ensemble enrichment, they can be made available with minimum additional computations.

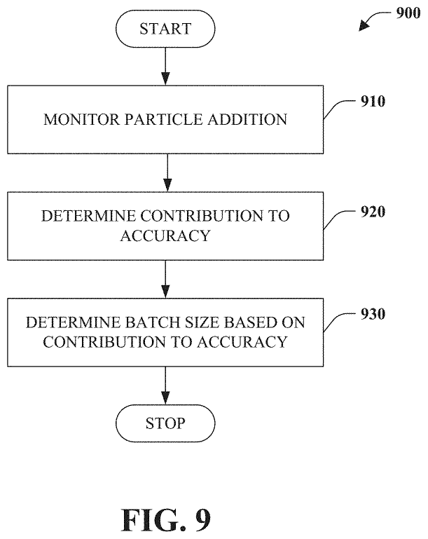

FIG. 9 shows a method 900 for determining batch size for at least particle addition. The method 900 can be performed by system 100 or various components thereof. At reference numeral 910, particle addition is monitored. Particle addition can occur when particles are initially added to an ensemble as well as when an ensemble is enhanced by increasing the number of particles to achieve a desired level of accuracy. Monitoring can include identifying particles and information regarding the particles that are being added to an ensemble. At reference 920, particles identified through monitoring, can be analyzed to determine how they contribute to accuracy. This can be determined based on a particle by particle basis or as a set or batch of particles. For instance, as particles are added to an ensemble sequentially, the contribution to accuracy can be determined. At reference numeral 930, a batch size is determined based on contribution of individual particles or sets of particles to accuracy as well as a difference between current accuracy and required accuracy. For instance, if an increase in accuracy of “x” is required and each particle contributes “y” to accuracy, batch size can be determined to include the number of particles such that the sum of their individual contributions “y” is equal to the increase in accuracy “x.” Further, consider a situation in which past enhancements where made based on a set of fifty particles at a time and it was repeated six times to improve accuracy a particular amount. The next time a batch size can be determined to be three hundred to improve the accuracy the same amount.

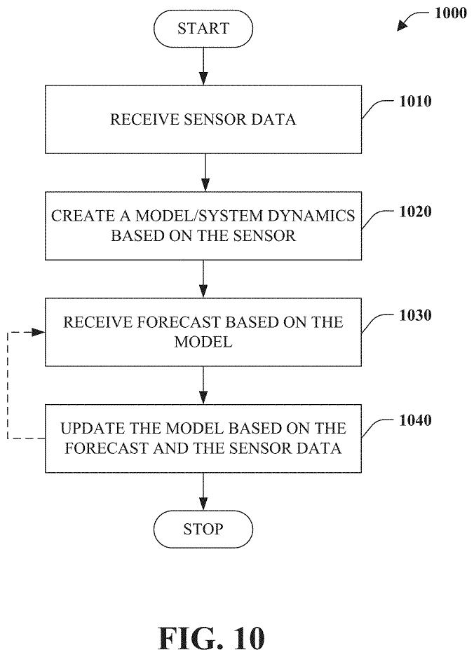

FIG. 10 is a flow chart diagram of a method of generating a model, which can be performed by the learning component 410. The model can provide system dynamics information that can be utilized for forecasting or other prognostics regarding the system or process model. In some situations, system dynamics information can be known and simply provided as input. In other situations, a model may not be available. At numeral 1010, sensor data can be received from one or more sensors associated with a system or process of interest. At 1020, a model or system dynamics can be created based on the sensor data. For example, sensor data over time can be analyzed to determine patterns and dependencies utilizing artificial intelligence-based techniques such as, but not limited to, neural networks. At 1030, a forecast can be generated based on the model. At 1040, the model can be updated based on the forecast as well as additional sensor data. For instance, the forecast can be compared with actual results captured by sensor data and used to update the model to account for differences. The process can optionally loop back to 1030 as shown by the dashed arrow to continuously learn based on produced forecasts.

The robustness, scalability, and overall versatility of this system or platform allows it to be applicable to a broad range of fields. Any industry application that requires decision making support or system prognostics for a dynamically changing process will find this useful. A non-exhaustive list of such applications includes space situational awareness, prognostics for electric automobiles, prognostics for aerospace propulsion, decision making support for wind farms, prognostics/reliability assessment in chemical and nuclear process industries, and decision-making support for structural design.

The ultimate objective of space situational awareness (SSA) is to track man-made objects in space, including defunct satellites and other objects classified as debris. This is done in order to provide decision-making processes with a quantifiable and timely body of evidence (e.g., predictive, imminent, or forensic) of behaviors attributable to specific space domain threats or hazards. The adaptive particle forecasting system, described herein, provides an unprecedented capability for SSA, namely the ability to forecast satellite/debris states with guaranteed accuracy of computation of probability of collision between objects of interest.

Advancements and gain in popularity of electrified vehicle technologies strongly motivate work in aging characterization, state of health (SOH) estimation and remaining useful life (RUL) prediction of automobile batteries (e.g., lithium-ion). Reduced order models are often employed to capture the complex chemical processes underlying battery aging. These models can be combined with the forecasting techniques provided herein to provide robust prognostics of remaining battery useful life. This can be used for improvements in battery design.

Robust simulation of multi-physics combustion processes within an aircraft or rocket engine is a daunting task. Designers look to accurately characterize processes that lead to combustion instabilities so that they may be avoided in flight. The subject forecasting system can be combined with reduced order dynamic models of combustion processes in order to provide guaranteed forecasts of incidence of combustion in stabilities.

Participation in wind farms in the so-called “day ahead of electricity market” requires robust forecasts of available wind at the wind-farm site for a forecast window of forty-eight to seventy-two hours. The physics of wind flow is extremely complex and depends on local conditions, topography, orography, farm effects, and other factors. The subject particle system is suitable for characterizing state uncertainty in the underlying complex flow models and can deliver guaranteed estimates of available power generation capability at wind farm sites.

Safety analysis of chemical processes and nuclear plants have to forecast the underlying complex processes for very long durations, sometimes extending several years. The error buildup during such prognostications can be significant, so much as to erode confidence in obtained results. The subject forecasting system avoids these pitfalls on account of its self-corrective nature and can provide guaranteed estimates of desired prognostic metrics for highly complex chemical and nuclear processes.

The design cycle of structural components often requires prediction of their response to random loads. Low confidence predictions, or predictions without guarantees can force the designers to include large safety margins, which in turn lead to heavy, or suboptimal design. The forecasting system provided herein can be employed to provide guaranteed estimates of structural failure, thus providing designers with robust system knowledge that can assist with increasing optimality in structural design.

Aspects of the subject disclosure concern a technical problem of accuracy of particle forecasting systems. Conventional systems employ fixed size ensembles and are unable to guarantee the accuracy of their predictions. The technical solution involves adaptive ensembles that can be adjusted to guarantee accuracy of a prediction. More specifically, the ensemble can be adjusted during processing to add particles needed to guarantee a minimum desired level of accuracy. Further, when accuracy is more than is required, particles can be removed from the ensemble for computational efficiency. Various other aspects concern generating an efficient sample, determining an optimal batch size, identifying optimal particles for a batch, and learning a model of system or process, among other things.

The subject disclosure provides for various products and processes that are configured to perform adaptive particle-based forecasting and various functionality related thereto. What follows are one or more example systems and methods.

A system comprises a processor coupled to a memory that includes instructions that when executed by the processor cause the processor to: compute current accuracy of a particle filter with respect to a quantity of interest, wherein the current accuracy is determined prior to generation of forecast by the particle filter; detect a deviation from an accuracy bound associated with the quantity of interest based on a comparison of the current accuracy with the accuracy bound; and add one or more particles to an ensemble employed by the particle filter when the accuracy is less than a minimum threshold to increase the accuracy to meet or exceed the minimum threshold, wherein particles are added in one or more batches. The instructions can further cause the processor to determine batch size based on a change in error variance, which causes the accuracy to meet or exceed the minimum threshold, and sensitivity of the error variance to change in ensemble discrepancy. The instructions further cause the processor to identify the particles based on a probabilistic technique for approximating a global optimum of a discrepancy function of the ensemble. In one instance, the probabilistic technique is simulated annealing. The technique can further be applied recursively to generate a number of particles for a batch of the one or more batches, and, in one scenario, each recursive thread is executed on a parallel processor. The instructions can further cause the processor to remove one or more particles from the ensemble employed by the particle filter when the accuracy is greater than a maximum threshold to reduce the accuracy below the maximum threshold. The instructions further cause the processor to identify the one or more particles from a uniform distribution followed by comparison with a removal probability that accounts for significance of a particle to the ensemble. In one instance, the removal probability is based on a value of a probability density function for a particle. In one embodiment, the particle filter predicts failure of a jet engine.

A method comprises computing current accuracy of a particle filter with respect to a quantity of interest, wherein the current accuracy is determined prior to generation of forecast by the particle filter, determining a deviation from an accuracy bound associated with the quantity of interest based on a comparison of the current accuracy with the accuracy bound, and adding one or more particles to an ensemble employed by the particle filter when the accuracy is less than a minimum threshold to increase the accuracy to meet or exceed the minimum threshold, wherein particles are added in one or more batches. The method further comprises determining batch size based on a change in error variance, which causes the accuracy to meet or exceed the minimum threshold, and sensitivity of the error variance to change in ensemble discrepancy. The method further comprises identifying the one or more particles based on probabilistic technique for approximating a global optimum of a discrepancy function with respect to the ensemble. Further, the method comprises identifying multiple particles of the one or more particles simultaneously with parallel processing. The method can also comprise removing one or more particles from the ensemble employed by the particle filter, when the accuracy is greater than a maximum threshold, to reduce the accuracy below the maximum threshold. In one instance, the method also comprises identifying the one or more particles from a uniform distribution followed by comparison with a removal probability that accounts for significance of a particle to the ensemble.

An adaptive particle filtering method is executed on a process with instructions that cause the processor to perform the following operations: generating an initial ensemble by sampling, propagating each particle in the initial ensemble to a current ensemble based on system dynamics, determining a current error with respect to a quantity of interest, and adding particles in at least one batch to the current ensemble when the current error is greater than a low error threshold, until the current error is less than or equal to the low error threshold. The operations further comprise sampling from a uniform distribution sequentially such that at any point in the process the initial ensemble maximizes space-filling and non-collapsing criteria. The operations further comprise determining a size of the at least one batch based on a change in error variance corresponding to a difference between the current error and error threshold and sensitivity of the error variance to change in ensemble discrepancy. The operations further comprise executing simulated annealing recursively and in parallel to identify multiple particles, wherein simulated annealing probabilistically approximates global optimums of a discrepancy function with respect to the ensemble.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

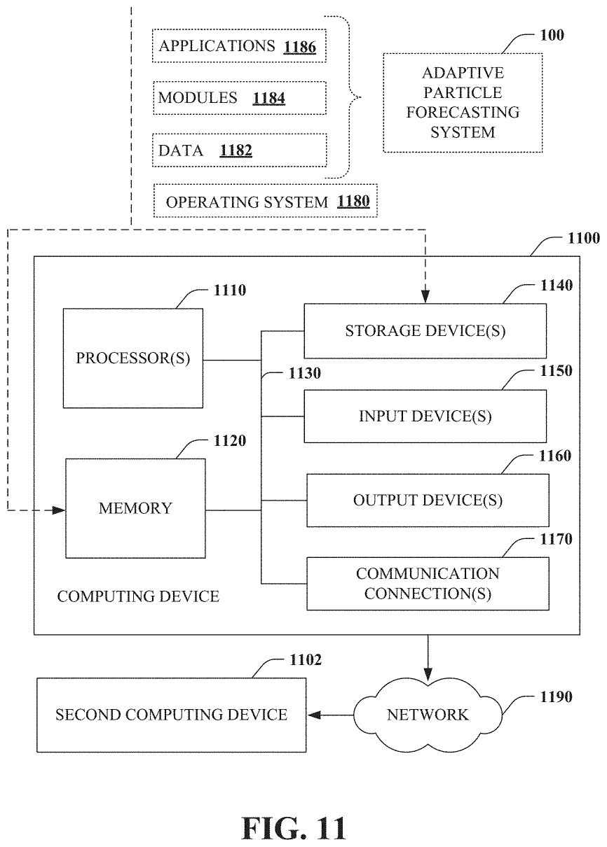

To provide a context for the disclosed subject matter, FIG. 11 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 11, illustrated is an example computing device 1100 (e.g., desktop, laptop, tablet, watch, server, hand-held, programmable consumer or industrial electronics, set-top box, game system, compute node . . . ). The computing device 1100 includes one or more processor(s) 1110, memory 1120, system bus 1130, storage device(s) 1140, input device(s) 1150, output device(s) 1160, and communications connection(s) 1170. The system bus 1130 communicatively couples at least the above system constituents. However, the computing device 1100, in its simplest form, can include one or more processors 1110 coupled to memory 1120, wherein the one or more processors 1110 execute various computer executable actions, instructions, and or components stored in the memory 1120.

The processor(s) 1110 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1110 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 1110 can be a graphics processor unit (GPU) that performs calculations with respect to digital image processing and computer graphics.

The computing device 1100 can include or otherwise interact with a variety of computer-readable media to facilitate control of the computing device to implement one or more aspects of the disclosed subject matter. The computer-readable media can be any available media that is accessible to the computing device 1100 and includes volatile and nonvolatile media, and removable and non-removable media. Computer-readable media can comprise two distinct and mutually exclusive types, namely storage media and communication media.

Storage media includes volatile and nonvolatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 1100. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

The memory 1120 and storage device(s) 1140 are examples of computer-readable storage media. Depending on the configuration and type of computing device, the memory 1120 may be volatile (e.g., random access memory (RAM)), non-volatile (e.g., read only memory (ROM), flash memory . . . ) or some combination of the two. By way of example, the basic input/output system (BIOS), including basic routines to transfer information between elements within the computing device 1100, such as during start-up, can be stored in nonvolatile memory, while volatile memory can act as external cache memory to facilitate processing by the processor(s) 1110, among other things.

The storage device(s) 1140 include removable/non-removable, volatile/non-volatile storage media for storage of vast amounts of data relative to the memory 1120. For example, storage device(s) 1140 include, but are not limited to, one or more devices such as a magnetic or optical disk drive, floppy disk drive, flash memory, solid-state drive, or memory stick.

Memory 1120 and storage device(s) 1140 can include, or have stored therein, operating system 1180, one or more applications 1186, one or more program modules 1184, and data 1182. The operating system 1180 acts to control and allocate resources of the computing device 1100. Applications 1186 include one or both of system and application software and can exploit management of resources by the operating system 1180 through program modules 1184 and data 1182 stored in the memory 1120 and/or storage device(s) 1140 to perform one or more actions. Accordingly, applications 1186 can turn a general-purpose computer 1100 into a specialized machine in accordance with the logic provided thereby.

All or portions of the disclosed subject matter can be implemented using standard programming and/or engineering techniques to produce software, firmware, hardware, or any combination thereof to control the computing device 1100 to realize the disclosed functionality. By way of example and not limitation, all or portions of the adaptive particle forecasting system 100 can be, or form part of, the application 1186, and include one or more modules 1184 and data 1182 stored in memory and/or storage device(s) 1140 whose functionality can be realized when executed by one or more processor(s) 1110.

In accordance with one particular embodiment, the processor(s) 1110 can correspond to a system on a chip (SOC) or like architecture including, or in other words integrating, both hardware and software on a single integrated circuit substrate. Here, the processor(s) 1110 can include one or more processors as well as memory at least similar to the processor(s) 1110 and memory 1120, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the adaptive particle forecasting system 100 and/or functionality associated therewith can be embedded within hardware in an SOC architecture.

The input device(s) 1150 and output device(s) 1160 can be communicatively coupled to the computing device 1100. By way of example, the input device(s) 1150 can include a pointing device (e.g., mouse, trackball, stylus, pen, touch pad . . . ), keyboard, joystick, microphone, voice user interface system, camera, motion sensor, and a global positioning satellite (GPS) receiver and transmitter, among other things. The output device(s) 1160, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 1150 and output device(s) 1160 can be connected to the computing device 1100 by way of wired connection (e.g., bus), wireless connection (e.g., Wi-Fi, Bluetooth . . . ), or a combination thereof.

The computing device 1100 can also include communication connection(s) 1170 to enable communication with at least a second computing device 1102 by means of a network 1190. The communication connection(s) 1170 can include wired or wireless communication mechanisms to support network communication. The network 1190 can correspond to a local area network (LAN) or a wide area network (WAN) such as the Internet. The second computing device 1102 can be another processor-based device with which the computing device 1100 can interact. For example, the computing device 1100 can form part of a network service platform that exposes the adaptive particle forecasting system 100 as a service to the second computing device 1102. In another instance, the computing device 1100 and second computing device 1102 can correspond to a parallel architecture to allow distributed processing between the devices, for example for selection of optimal particles with which to enhance and ensemble.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A system, comprising:
a processor coupled to a memory that includes instructions that when executed by the processor cause the processor to:
compute current accuracy of a particle filter with respect to a quantity of interest, wherein the current accuracy is determined prior to generation of a forecast by the particle filter;
detect a deviation from an accuracy bound associated with the quantity of interest based on a comparison of the current accuracy with the accuracy bound; and
add one or more particles to an ensemble employed by the particle filter when the accuracy is less than a minimum threshold to increase the accuracy to meet or exceed the minimum threshold, wherein particles are added in one or more batches.

2. The system of claim 1, further comprises instructions that cause the processor to determine batch size based on a change in error variance, which causes the accuracy to meet or exceed the minimum threshold, and sensitivity of the error variance to change in ensemble discrepancy.

3. The system of claim 1, further comprises instructions that cause the processor to identify the particles based on probabilistic technique for approximating a global optimum of a discrepancy function the ensemble.

4. The system of claim 3, wherein the probabilistic technique is simulated annealing.

5. The system of claim 3, wherein the technique is applied recursively to generate a number of particles for a batch of the one or more batches.

6. The system of claim 5, wherein each recursive thread is executed on a parallel processor.

7. The system of claim 1, further comprising instructions that cause the processor to remove one or more particles from the ensemble employed by the particle filter when the accuracy is greater than a maximum threshold to reduce the accuracy below the maximum threshold.

8. The system of claim 7, further comprising instructions that cause the processor to identify the one or more particles from a uniform distribution followed by comparison with a removal probability that accounts for significance of a particle to the ensemble.

9. The system of claim 8, wherein the removal probability is computed based on a value of a probability density function for a particle.

10. The system of claim 1, wherein the particle filter predicts failure of a jet engine.

11. A method, comprising:
computing current accuracy of a particle filter with respect to a quantity of interest, wherein the current accuracy is determined prior to generation of forecast by the particle filter;
determining a deviation from an accuracy bound associated with the quantity of interest based on a comparison of the current accuracy with the accuracy bound; and
adding one or more particles to an ensemble employed by the particle filter when the accuracy is less than a minimum threshold to increase the accuracy to meet or exceed the minimum threshold, wherein particles are added in one or more batches.

12. The method of claim 11, further comprising determining batch size based on a change in error variance, which causes the accuracy to meet or exceed the minimum threshold, and sensitivity of the error variance to change in ensemble discrepancy.

13. The method of claim 12, further comprising identifying the one or more particles based on probabilistic technique for approximating a global optimum of a discrepancy function with respect to the ensemble.

14. The method of claim 13, further comprising identifying multiple particles of the one or more particles simultaneously with parallel processing.

15. The method of claim 12, further comprising removing one or more particles from the ensemble employed by the particle filter, when the accuracy is greater than a maximum threshold, to reduce the accuracy below the maximum threshold.

16. The method of claim 15, further comprising identifying the one or more particles from a uniform distribution followed by comparison with a removal probability that accounts for significance of a particle to the ensemble.

17. A method of adaptive particle filtering comprising:
executing, on a processor, instructions that cause the processor to perform the following operations:
generating an initial ensemble by sampling;
propagating each particle in the initial ensemble to a current ensemble based on system dynamics;
determining a current error with respect to a quantity of interest; and
adding particles in at least one batch to the current ensemble when the current error is greater than a low error threshold until the current error is less than or equal to the low error threshold.

18. The method of claim 17, the operations further comprising sampling from a uniform distribution sequentially such that at any point in the process the initial ensemble maximizes space-filling and non-collapsing criteria.

19. The method of claim 17, the operations further comprising determining a size of the at least one batch based on a change in error variance corresponding to a difference between the current error and error threshold and sensitivity of the error variance to change in ensemble discrepancy.

20. The method of claim 19, the operations further comprising executing simulated annealing recursively and in parallel to identify multiple particles, wherein simulated annealing probabilistically approximates global optimums of a discrepancy function with respect to the ensemble.
